(19) United States
(12) Patent Application Publication
(10) Pub. No.: US 2010/0095515 A1
(43) Pub. Date: Apr. 22, 2010

(54) METHOD AND APPARATUS FOR ASSEMBLING A CARRIAGE ASSEMBLY

(75) Inventors: Hidehiko Kira, Kawasaki (JP); Naoki Ishikawa, Kawasaki (JP); Kimio Nakamura, Kawasaki (JP); Takayoshi Matsumura, Kawasaki (JP)

Correspondence Address: STAAS & HALSEY LLP, SUITE 700, 1201 NEW YORK AVENUE, N.W., WASHINGTON, DC, 20005, US

(73) Assignee: TOSHIBA STORAGE DEVICE CORPORATION, Tokyo (JP)

(21) Appl. No.: 12/524,864

(22) PCT Filed: Mar. 15, 2007
(86) PCT No.: PCT/JP2007/055262

§ 371 Date: Jul. 29, 2009

(51) Int. Cl. B23P 19/00

(52) U.S. Cl. 29/602.1; 29/700

(57) ABSTRACT

A method of assembling a carriage assembly that is operable, during a crimping step that passes a ball, which has a diameter that is equal to or larger than an inner diameter of spacer holes of suspensions, successively through the spacer holes using a bar-shaped pressing member that is subjected to ultrasonic vibration to thereby crimp spacer hole inner circumferential portions of the spacer portions and attach the suspensions to the front end portions of the carriage arms, to prevent the pressing member that presses the ball from colliding with an inner circumferential surface and the like of the spacer holes of the spacer portions and is therefore able to substantially eliminate tilting from the standard angle of the suspensions due to deformation of the spacer portions, and an assembling apparatus that uses such method are provided.

After the ball 20 has passed through one of the spacer holes 12b, the inner diameter of the through-hole 36a of the gap maintaining plates 36 positioned to the rear of such spacer hole 12b in the direction in which the ball 20 passes is reduced to a smaller diameter than the inner diameter of the spacer holes 12b.

### FIELD

The present invention relates to a method of assembling a carriage assembly that is used in a magnetic disk apparatus and is constructed with suspensions attached to front end portions of carriage arms, and to an assembling apparatus that uses such method.

### BACKGROUND

FIG. 7 is a perspective view depicting a carriage assembly used in a magnetic disk apparatus.

In FIG. 7, reference numeral 10 denotes a carriage arm, a plurality of which are aligned in parallel corresponding to each surface of a plurality of magnetic disks provided in the magnetic disk apparatus. An engagement hole 10a is formed in the front tip portion of each carriage arm 10. The engagement holes 10a are formed with matching center axes. Reference numeral 12 denotes a suspension that is connected to the front end of each carriage arm 10 (in FIG. 7, only one suspension 12 is depicted and the other suspensions 12 are omitted). A magnetic head 14 is mounted on a front end portion of each suspension 12. Each magnetic head 14 is electrically connected to a control unit 18 via a flexible circuit board 16 attached to a side surface of the carriage arm 10. Reference numeral 19 denotes an actuator shaft that is fixed to a base portion of each carriage arm 10. By rotating the actuator shaft 19 around its axis, each carriage arm 10 carries out a seek operation on a plane that is parallel to the surfaces of the recording media.

The carriage assembly is formed by fixing the suspensions 12 by crimping to both surfaces of the front end portions of the respective carriage arms 10 that have been attached in parallel to the actuator shaft 19.

A conventional method of fixing the suspensions 12 to the carriage arms 10 is disclosed in Patent Document 1. FIG. 8 and FIG. 9 depict the method disclosed in Patent Document 1 for fixing the suspensions 12 to the carriage arms 10.

In this method, first, a suspension 12 is attached on both the front and the rear of each carriage arm 10 with a spacer hole 12b provided in a spacer portion 12a of each suspension 12 having been positioned with respect to the engagement hole 10a formed in the front end portion of each carriage arm 10. After this, a metal ball 20 formed with a slightly larger diameter than the inner diameter of the spacer holes 12b is pressed using a pressing shaft 22 as a pressing member so as to pass through the spacer holes 12b. As depicted in FIG. 8, the metal ball 20 is thrust forward by the pressing shaft 22 so as to successively pass through inside the engagement holes 10a that have been aligned and the spacer holes 12b that have been positioned thereupon.

Since the metal ball 20 is formed with a slightly larger diameter than the spacer holes 12b, when the metal ball 20 passes through a spacer hole 12b, the metal ball 20 acts so as to press open a crimping portion 13 formed on an inner circumferential edge of the spacer hole 12b and as a result, the spacer portion 12a of the suspension 12 is fixed by crimping so as to “bite into” the carriage arm 10.

In this way, when assembling a carriage assembly, since the metal ball 20 is used to press open the spacer holes 12b and thereby fix the suspensions 12 to the carriage arms 10 by crimping, a problem may occur in that the spacer portions 12a deform due to the stress that acts thereupon during crimping, resulting in the suspensions 12 becoming displaced from the standard positions. That is, when the suspensions 12 are fixed to the carriage arms 10 by crimping, the spacer portions 12a become bent, which can result in the suspensions 12 becoming tilted with respect to the standard angle. Tilting of the suspensions 12 affects the float heights of the magnetic heads 14 above the surfaces of the recording media, resulting in fluctuations in the float heights of the magnetic heads 14 above the surfaces of the recording media.

The storage capacity of modem magnetic disk apparatuses has greatly increased in recent years, which has led to decreases in the float height of magnetic heads above the surfaces of recording media. This means that fluctuations in the float height of magnetic heads have a large effect on the information reading and writing characteristics, and therefore it is necessary to suppress fluctuations in the float height of the magnetic heads to achieve the required characteristics.

Patent Document 1 also discloses a method of assembling a carriage assembly that can suppress deformation of the spacer portions 12a due to the stress applied during crimping. FIG. 10 is a diagram useful in explaining a method of assembling a carriage assembly using an ultrasonic horn 32 which is disclosed in Patent Document 1 as a method of assembling that can suppress such deformation.

The method of assembling a carriage assembly disclosed in Patent Document 1 is characterized by using the ultrasonic horn 32 to pass the metal ball 20 through the spacer holes 12b. The metal ball 20 is the same as the metal ball 20 used in the method of assembling a carriage assembly described above. FIG. 10 depicts a state where gap maintaining plates 36 have been inserted between adjacent carriage arms 10 and pressure applying plates 37a, 37b have been placed in contact with both end surfaces of the carriage arms 10 so that the respective carriage arms 10 are supported by being sandwiched on both sides thereof.

The ultrasonic horn 32 applies ultrasonic vibration in the axial direction and due to the action of the ultrasonic horn 32, the metal ball 20 causes less damage to the spacer portions 12a during crimping. This means that deformation is prevented when the suspensions 12 are attached to the carriage arms 10 and the suspensions 12 can be fixed to the carriage arms 10 more accurately. The reason for this is thought to be that the stress caused by the ultrasonic vibration of the ultrasonic horn 32 and the static stress due to the metal ball 20 pressing open the crimping portions 13 act so as to be superimposed, which makes it possible to reduce the resistance to deformation, and by reducing the average machining force by using a striking action that is repeated at high speed, it is possible to fix the members while suppressing deformation of the fixed portions of the suspensions 12 and the carriage arms 10.

### Patent Document 1

Japanese Laid-Open Patent Publication No. 2004-127491 (see paragraphs 0003, 0004, 0015, 0023, and 0024 and FIGS. 3, 5, and 6).

### SUMMARY

However, with the above conventional method that presses the metal ball 20 using the bar-shaped ultrasonic horn 32 (pressing member) to which ultrasonic vibration is applied, at the instant when the metal ball 20 passes through the spacer hole 12b, the stress that was applied to the ultrasonic horn 32 will be suddenly released, resulting in the ultrasonic horn 32 deforming so as to become significantly bent as depicted in FIG. 11. This means that there is a problem that in some cases, the ultrasonic horn 32 will strike the inner circumferential surface or the like of the spacer holes 12b of the spacer portions 12a and cause deformation of the spacer portions 12a.

If the spacer portions 12a become deformed in this way due to being hit by the ultrasonic horn 32, the spacer portions 12a will become bent, which results in the suspensions 12 becoming tilted with respect to the standard angle.

The present invention was conceived to solve the problem described above and it is an object of the present invention to provide a method of assembling a carriage assembly that is capable of preventing a pressing member that presses a ball from colliding with an inner circumferential surface and the like of spacer holes of spacer portions and is therefore able to substantially eliminate tilting from the standard angle of the suspensions due to deformation of the spacer portions, and to also provide an assembling apparatus that uses such method.

To solve the problem described above, a method of assembling a carriage assembly according to the present invention has the following construction.

That is, the method includes: an attaching step of positioning spacer holes provided in spacer portions of suspensions on through-holes that are formed with matching center axes in front end portions of a plurality of carriage arms that are used in a magnetic disk apparatus and have been disposed in parallel and attaching the suspensions to the respective carriage arms; a holding step of inserting gap maintaining plates, in which through-holes that connect to the spacer holes have been formed, between adjacent carriage arms and holding the carriage arms by clamping in the direction in which the carriage arms are aligned; and a crimping step of pressing a ball with a diameter that is equal to or larger than an inner diameter of the spacer holes using a bar-shaped pressing member that is subjected to ultrasonic vibration so as to pass the ball successively through the spacer holes of the respective suspensions and thereby crimp spacer hole inner circumferential portions of the spacer portions and attach the suspensions to the front end portions of the carriage arms, wherein in the crimping step, after the ball has passed through one spacer hole out of the spacer holes, an inner diameter of the through-hole of the gap maintaining plates positioned to the rear of the spacer hole in the direction in which the ball passes is reduced to a smaller diameter than the inner diameter of the spacer holes.

By doing so, when the pressing member deforms, the pressing member will collide with the inner circumferential surface of the through-hole of the gap maintaining plates, thereby making the pressing member less susceptible to colliding with the inner circumferential surfaces of the spacer holes.

Another method includes: an attaching step of positioning spacer holes provided in spacer portions of suspensions on through-holes that are formed with matching center axes in front end portions of a plurality of carriage arms that are used in a magnetic disk apparatus and have been disposed in parallel and attaching the suspensions to the respective carriage arms; a holding step of inserting gap maintaining plates, in which through-holes that connect to the spacer holes have been formed, between adjacent carriage arms and holding the carriage arms by clamping in the direction in which the carriage arms are aligned; and a crimping step of pressing a ball with a diameter that is equal to or larger than an inner diameter of the spacer holes using a bar-shaped pressing member that is subjected to ultrasonic vibration so as to pass the ball successively through the spacer holes of the respective suspensions and thereby crimp spacer hole inner circumferential portions of the spacer portions and attach the suspensions to the front end portions of the carriage arms, wherein a large-diameter portion, which has a larger diameter than other parts of the pressing member but a smaller diameter than an inner diameter of the through-holes, is formed on the pressing member at a nodal point of the ultrasonic vibration.

By doing so, the large-diameter portion of the pressing member will collide with the inner circumferential surface of the through-hole of the gap maintaining plates, which suppresses the bending (deformation) of the pressing member and thereby makes the pressing member less susceptible to colliding with the inner circumferential surfaces of the spacer holes.

In addition, the large-diameter portion is formed with a spherical surface.

Also, during the crimping step, the large-diameter portion of the pressing member is held so as to not shake while the large-diameter portion is advancing inside a spacer hole.

By doing so, since bending (deformation) of the pressing member is suppressed by suppressing shaking of the large-diameter portion before the large-diameter portion of the pressing member advances inside a spacer hole, the pressing member becomes less susceptible to colliding with the inner circumferential surfaces of the spacer holes.

Another method includes: an attaching step of positioning spacer holes provided in spacer portions of suspensions on through-holes that are formed with matching center axes in front end portions of a plurality of carriage arms that are used in a magnetic disk apparatus and have been disposed in parallel and attaching the suspensions to the respective carriage arms; a holding step of inserting gap maintaining plates, in which through-holes that connect to the spacer holes have been formed, between adjacent carriage arms and holding the carriage arms by clamping in the direction in which the carriage arms are aligned; and a crimping step of pressing a ball with a diameter that is equal to or larger than an inner diameter of the spacer holes using a bar-shaped pressing member that is subjected to ultrasonic vibration so as to pass the ball successively through the spacer holes of the respective suspensions and thereby crimp spacer hole inner circumferential portions of the spacer portions and attach the suspensions to the front end portions of the carriage arms, wherein at least an inner circumferential surface of a through-hole in the gap maintaining plates and a part of the pressing member that advances inside the spacer holes are magnetized with the same polarity.

By doing so, the inner circumferential surfaces of the through-holes of the gap maintaining plates and the pressing member will magnetically repulse one another, which suppresses bending (deformation) of the pressing member and thereby makes the pressing member less susceptible to colliding with the inner circumferential surfaces of the spacer holes.

To solve the problem described above, an assembling apparatus for a carriage assembly according to the present invention has the following construction.

That is, an assembling apparatus for a carriage assembly uses the method of assembling a carriage assembly according to claim 1 and includes: gap maintaining plates which are inserted between adjacent carriage arms in the attaching step in a state where the respective suspensions have been attached on the carriage arms and in which through-holes that connect to the spacer holes are formed; carriage holding means for holding the plurality of carriage arms by clamping in the direction in which the carriage arms are aligned; pressing means for pressing a bar-shaped pressing member in the direction of the center axes of the spacer holes so as to pass a ball, which has a diameter that is equal to or larger than the inner diameter of the spacer holes, successively through the spacer holes of the suspensions to crimp the spacer hole edge portions of the spacer portions and attach the suspensions to the front end portions of the respective carriage arms; ultrasonic vibration applying means for applying ultrasonic vibration to the pressing member; and through-hole diameter reducing means operable after the ball has passed one spacer hole out of the spacer holes, to reduce an inner diameter of the through-hole of the gap maintaining plates positioned to the rear of the spacer hole in the direction in which the ball passes to a smaller diameter than the inner diameter of the spacer holes.

By doing so, when the pressing member deforms, the pressing member will collide with the inner circumferential surface of the through-hole of the gap maintaining plates, thereby making the pressing member less susceptible to colliding with the inner circumferential surfaces of the spacer holes. Another assembling apparatus for a carriage assembly uses the method of assembling a carriage assembly according to claim 2 and includes: gap maintaining plates which are inserted between adjacent carriage arms in the attaching step in a state where the respective suspensions have been attached on the carriage arms and in which through-holes that connect to the spacer holes are formed; carriage holding means for holding the plurality of carriage arms by clamping in the direction in which the carriage arms are aligned; pressing means for pressing a bar-shaped pressing member in the direction of the center axes of the spacer holes so as to pass a ball, which has a diameter that is equal to or larger than the inner diameter of the spacer holes, successively through the spacer holes of the suspensions to crimp the spacer hole edge portions of the spacer portions and attach the suspensions to the front end portions of the respective carriage arms; and ultrasonic vibration applying means for applying ultrasonic vibration to the pressing member, wherein a large-diameter portion, which has a larger diameter than other parts of the pressing member but a smaller diameter than an inner diameter of the through-holes, is formed on the pressing member at a nodal point of the ultrasonic vibration.

By doing so, the large-diameter portion of the pressing member will collide with the inner circumferential surface of the through-hole of the gap maintaining plates, which suppresses the bending (deformation) of the pressing member and thereby makes the pressing member less susceptible to colliding with the inner circumferential surfaces of the spacer holes.

In addition, the large-diameter portion is formed with a spherical surface.

Also, during the crimping step, the large-diameter portion of the pressing member is held so as to not shake while the large-diameter portion is advancing inside a spacer hole.

By doing so, since bending (deformation) of the pressing member is suppressed by suppressing shaking of the large-diameter portion before the large-diameter portion of the pressing member advances inside a spacer hole, the pressing member becomes less susceptible to colliding with the inner circumferential surfaces of the spacer holes.

Another assembling apparatus for a carriage assembly uses the method of assembling a carriage assembly according to claim 5 and includes: gap maintaining plates which are inserted between adjacent carriage arms in the attaching step in a state where the respective suspensions have been attached on the carriage arms and in which through-holes that connect to the spacer holes are formed; carriage holding means for holding the plurality of carriage arms by clamping in the direction in which the carriage arms are aligned; pressing means for pressing a bar-shaped pressing member in the direction of the center axes of the spacer holes so as to pass a ball, which has a diameter that is equal to or larger than the inner diameter of the spacer holes, successively through the spacer holes of the suspensions to crimp the spacer hole edge portions of the spacer portions and attach the suspensions to the front end portions of the respective carriage arms; and ultrasonic vibration applying means for applying ultrasonic vibration to the pressing member, wherein the assembling apparatus magnetizes at least an inner circumferential surface of a through-hole in the gap maintaining plates and a part of the pressing member that advances inside the spacer holes with the same polarity.

By doing so, the inner circumferential surfaces of the through-holes of the gap maintaining plates and the pressing member will magnetically repulse one another, which suppresses bending (deformation) of the pressing member and thereby makes the pressing member less susceptible to colliding with the inner circumferential surfaces of the spacer holes.

### Effect of the Invention

According to a method of assembling and an assembling apparatus for a carriage assembly according to the present invention, by suppressing collisions between a pressing member that presses a ball and inner circumferential surfaces and the like of spacer holes of spacer portions, it is possible to substantially eliminate tilting from the standard angle of the suspensions due to deformation of the spacer portions.

### BRIEF DESCRIPTION OF THE DRAWINGS

FIG. 1 is a diagram useful in explaining a method of assembling a carriage assembly and an assembling apparatus according to a first embodiment of the present invention.

FIG. 2 is a diagram useful in explaining another example construction of the method of assembling a carriage assembly and the assembling apparatus according to the first embodiment of the present invention.

FIGS. 3A and 3B are diagrams useful in explaining the construction of gap maintaining plates in the method of assembling a carriage assembly and the assembling apparatus according to a first embodiment of the present invention.

FIG. 4 is a diagram useful in explaining a method of assembling a carriage assembly and an assembling apparatus according to a second embodiment of the present invention.

FIG. 5 is a diagram useful in explaining the method of assembling a carriage assembly and the assembling apparatus according to the second embodiment of the present invention.

FIG. 6 is a diagram useful in explaining a method of assembling a carriage assembly and an assembling apparatus according to a third embodiment of the present invention.

FIG. 7 is a perspective view of a carriage assembly.

FIG. 8 is a diagram useful in explaining an operation that fixes suspensions to carriage arms by crimping by passing a metal ball (“ball”) through spacer holes of the suspensions.

FIG. 9 is a diagram useful in explaining a method of assembling a carriage assembly.

FIG. 10 is a diagram useful in explaining a conventional method of assembling a carriage assembly.

FIG. 11 is a diagram useful in explaining a pressing member (ultrasonic horn) that has deformed so as to become bent.

### DESCRIPTION OF EMBODIMENTS

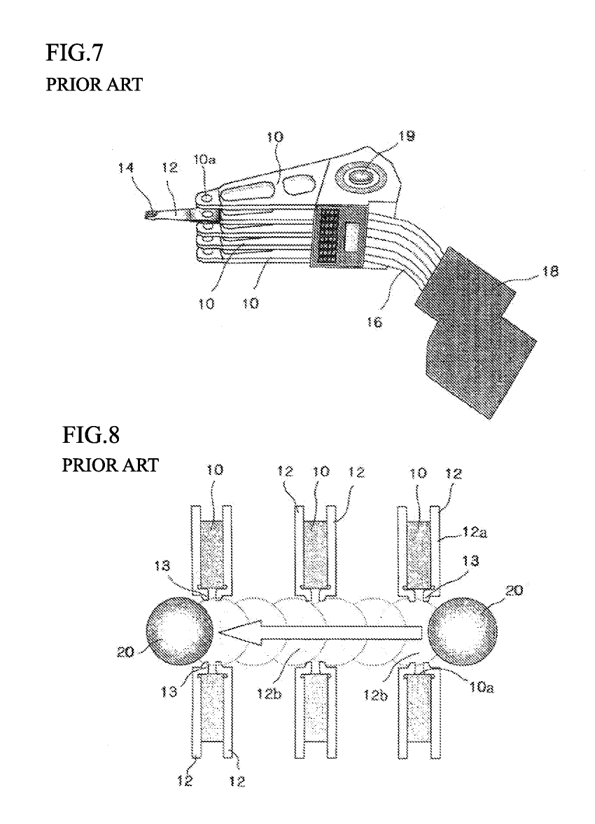

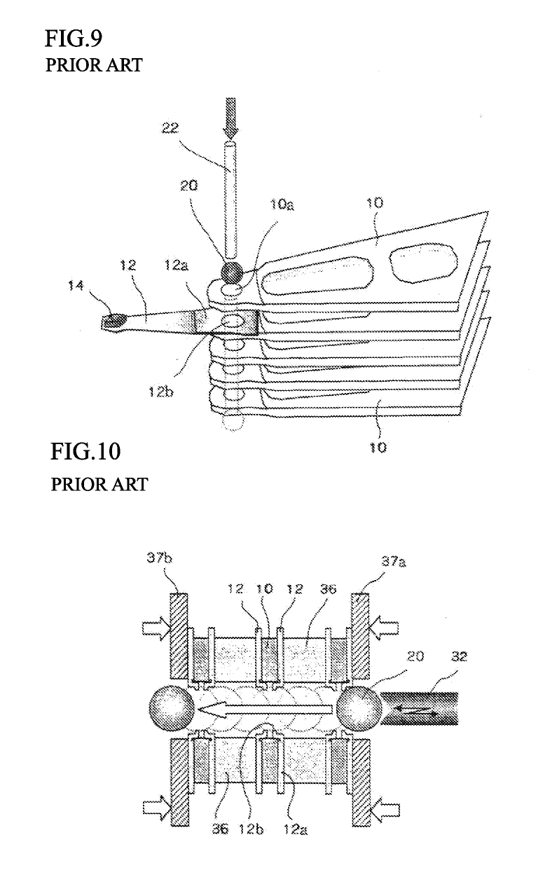

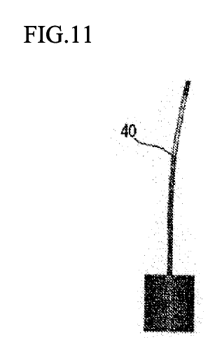

A carriage assembly to be assembled by a method of assembling a carriage assembly and an assembling apparatus according to embodiments of the present invention is depicted in FIG. 7. Since the construction of this carriage assembly has been described for the background art, description thereof is omitted here.

### First Embodiment

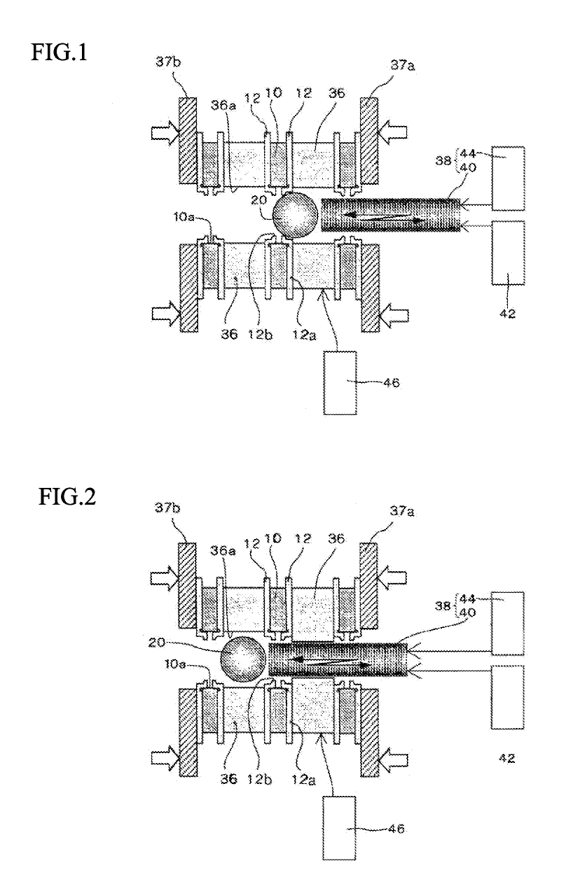

FIGS. 1 and 2 are diagrams useful in explaining a method of assembling a carriage assembly and an assembling apparatus according to a first embodiment. The apparatus for assembling a carriage assembly according to the first embodiment includes pressure applying plates 37a, 37b as carriage holding means, gap maintaining plates 36, pressing means 38 that presses a metal ball 20, an ultrasonic vibrating device 42 as an ultrasonic vibration applying means that applies ultrasonic vibration to the metal ball 20 via a pressing member 40 (described later), and through-hole diameter reducing means 46.

The pressure applying plates 37a, 37b as the carriage holding means clamp and support a plurality of carriage arms 10 from both sides in a state where suspensions 12 have been attached on the carriage arms 10 with spacer holes 12b of the suspensions 12 having been positioned on engagement holes 10a formed in front tip portions of the carriage arms 10 and where the gap maintaining plates 36 have been inserted between adjacent carriage arms 10.

Through-holes 36a are formed in the gap maintaining plates 36 and are provided so as to connect to the engagement holes 10a and the spacer holes 12b when the gap maintaining plates 36 are inserted between the carriage arms 10 as described above.

Openings 37c, 37d are also provided in the pressure applying plates 37a, 37b respectively so as to connect to the engagement holes 10a and the spacer holes 12b when the carriage arms 10 are clamped.

The pressing means 38 is composed of a bar-shaped (i.e., cylindrical) pressing member 40 (an “ultrasonic horn”) and a driving device 44 that is capable of driving and controlling the pressing member 40. The pressing member 40 is driven and controlled along an axis thereof by the driving device 44, and is provided so as to advance into and withdraw from the engagement holes 10a of the carriage arms 10 that are clamped by the pressure applying plates 37a, 37b and the spacer holes 12b that have been positioned with respect to the engagement holes 10a along the center axis of such holes.

The ultrasonic vibrating device 42 as the ultrasonic vibration applying means includes an ultrasonic vibrator that is connected to the pressing member 40, and by causing ultrasonic vibration of the ultrasonic vibrator, ultrasonic vibration is applied to the pressing member 40. The vibration direction of the ultrasonic vibration applied by the ultrasonic vibrating device 42 is the axial direction of the pressing member 40 (i.e., such vibration is so-called “longitudinal waves”), but is not especially limited to such.

The through-hole diameter reducing means 46 includes a load cell that detects the load stress applied to the pressing member 40 and a control unit composed of a computer that drives and controls a diameter reducing mechanism that reduces the inner diameter of the through-holes 36a of the gap maintaining plates 36 to a smaller diameter than the inner diameter of the spacer holes 12b. Note that even when the inner diameter of the through-holes 36a has been reduced, such diameter is still larger than the outer diameter of the pressing member 40.

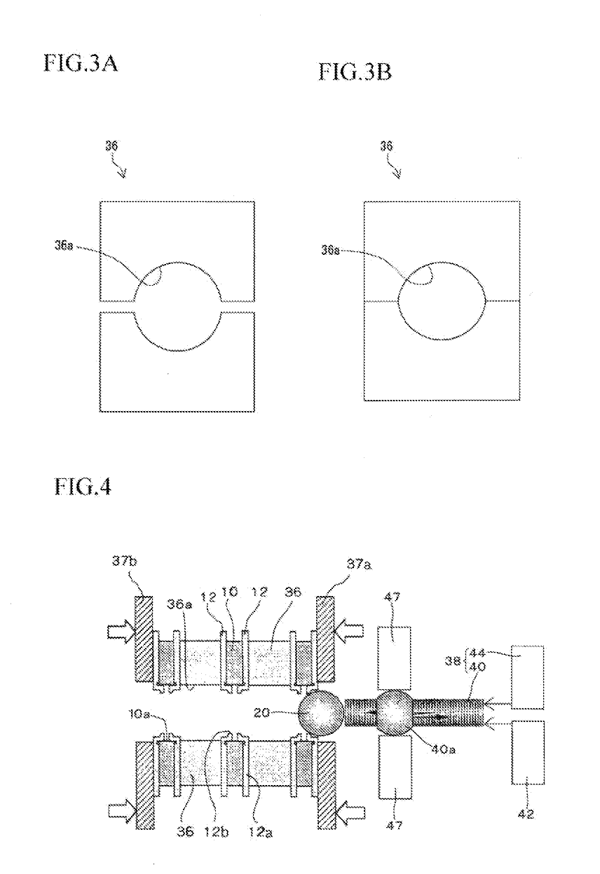

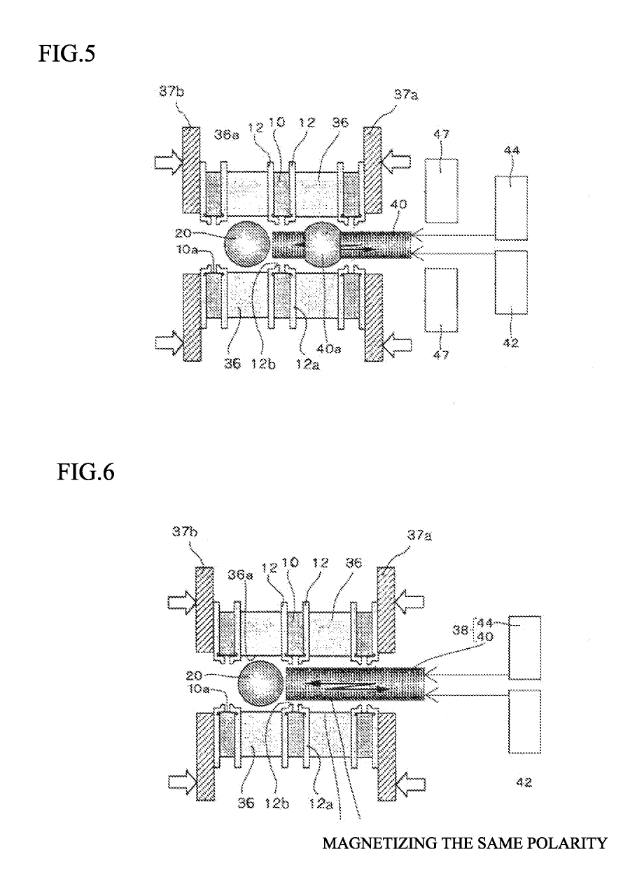

As depicted in FIGS. 3A and 3B, for example, the diameter reducing mechanism is provided by constructing each of the gap maintaining plates 36 from two plates with semicircular cutaway portions, and by disposing the two plates so that the cutaway portions face one another, the cutaway portions will join to form one of the through-holes 36a. When the gap maintaining plates 36 are inserted between the carriage arms 10, a certain gap is provided between the two plates (see FIG. 3A), and by carrying out driving control that reduces the gap using a solenoid, for example, a mechanism that reduces the diameter of the through-holes 36a may be realized (see FIG. 3B).

Alternatively, the diameter reducing mechanism may be a mechanism where the gap maintaining plates 36 are constructed of a piezoelectric element and deformation that occurs when a voltage is applied to the piezoelectric element is used to reduce the diameter of a through-hole 36a.

Next, the method of assembling a carriage assembly using the assembling apparatus for a carriage assembly according to the first embodiment will be described.

### Attaching Process

First, the suspensions 12 are attached with the spacer holes having been positioned on the respective engagement holes 10a formed in the front end portions of the carriage arms 10 so as to match the engagement holes 10a. The suspensions 12 are assembled on both the front and the rear of each carriage arm 10 aside from the carriage arms 10 at both ends out of the carriage arms 10 disposed in parallel.

### Holding Process

Next, the carriage assembly is held by the assembling apparatus for a carriage assembly. That is, as depicted in FIG. 1, a state is produced where the gap maintaining plates 36 are inserted between adjacent carriage arms 10, the pressure applying plates 37a, 37b are placed in contact with both end surfaces of the carriage arms 10, and the carriage arms 10 are held by being sandwiched on both sides in the direction in which the carriage arms 10 are aligned.

### Crimping Process

In this state, the metal ball 20 is passed through the spacer holes 12b by the pressing means 38.

That is, first, the metal ball 20 is positioned with respect to the spacer hole 12b of the suspension 12 attached to the endmost carriage arm 10 out of the aligned carriage arms 10 (in this example, the carriage arm 10 on the pressure applying plate 37a side) and is disposed on one side of the spacer hole 12b. After this, the pressing member 40 is moved and controlled by the driving device 44 so that the front end portion of the pressing member 40 comes into contact with the metal ball 20 and the pressing member 40 is moved so as to be inserted into the spacer hole 12b. At this time, the ultrasonic vibrating device 42 is driven and by applying ultrasonic vibration to the pressing member 40, the metal ball 20 is successively passed through the respective spacer holes 12b.

Since the metal ball 20 is formed with a slightly larger diameter than the spacer holes 12b, when the metal ball 20 passes through a spacer hole 12b, a crimping portion 13 formed at the inner circumferential edge of the spacer hole 12b is pressed open, and by doing so, the spacer portion 12a of the suspension 12 is crimped and fixed so as to bite into the carriage arm 10.

In the method of assembling a carriage assembly according to the first embodiment, the through-hole diameter reducing means 46 operates during the crimping process described above.

When the control unit of the through-hole diameter reducing means 46 has detected, via the load cell, a sudden drop in the load stress that is applied to the pressing member 40 due to the metal ball 20 having passed through one spacer hole 12b, the control unit drives and controls the diameter reducing mechanism as depicted in FIG. 2 so as to reduce the inner diameter of the through-hole 36a in the gap maintaining plates 36 positioned to the rear in the direction of movement of the metal ball 20 of the spacer hole 12b that has just been passed.

By doing so, when the pressing member 40 has deformed so as to become bent, the pressing member 40 will collide with the inner circumferential surface of the through-hole 36a in the gap maintaining plates 36, which makes the pressing member 40 less susceptible to colliding with the inner circumferential surfaces of the spacer holes 12b.

Accordingly, it is possible to suppress deformation of the spacer portion 12a due to the pressing member 40 colliding therewith, and it is therefore possible to prevent the suspensions 12 from becoming tilted with respect to the standard angle due to deformation of the spacer portions 12a.

### Second Embodiment

Next, a method of assembling a carriage assembly and an assembling apparatus according to a second embodiment will be described with reference to FIGS. 4 and 5. Note that in the second embodiment, constructions that are the same as in the first embodiment have been assigned the same reference numerals and description thereof is omitted.

The assembling apparatus of a carriage assembly according to the second embodiment has a mechanism for suppressing deformation of the pressing member 40 in place of the through-hole diameter reducing means 46 of the first embodiment. This mechanism will now be described.

As depicted in FIG. 4, on the pressing member 40 of the assembling apparatus of a carriage assembly according to the second embodiment, a large-diameter portion 40a that has a wider diameter than other parts of the pressing member 40 but is still narrower than the inner diameter of the through-holes 36a is formed at the position of a nodal point (a point with no amplitude) of the ultrasonic vibration applied by the ultrasonic vibrating device 42. The large-diameter portion 40a is formed with a spherical surface.

In addition, the assembling apparatus of a carriage assembly according to the second embodiment includes a large-diameter portion holding means 47 that holds the large-diameter portion 40a without shaking until the large-diameter portion 40a has advanced inside the spacer hole 12b. The large-diameter portion holding means 47 is provided so as to be capable of moving in accordance with movement of the pressing member 40.

Aside from using the large-diameter portion holding means 47 in place of the through-hole diameter reducing means 46 and additionally using the large-diameter portion 40a, the composition of a method of assembling a carriage assembly that uses the assembling apparatus for a carriage assembly according to the second embodiment is the same as in the first embodiment. Parts that differ to the first embodiment will now be described.

In the second embodiment, first, as depicted in FIG. 4, a crimping process starts in a state where the large-diameter portion 40a is held by being sandwiched by the large-diameter portion holding means 47. The large-diameter portion holding means 47 moves in accordance with the movement of the pressing member 40 and continues to hold the large-diameter portion 40a until the large-diameter portion 40a advances inside a spacer hole 12b. When the large-diameter portion 40a has reached a point just before the spacer hole 12b, the holding by the large-diameter portion holding means 47 is released.

Note that the large-diameter portion holding means 47 is not limited to the construction described above and may be constructed so that the large-diameter portion 40a is inserted inside an opening, for example. In this case, if the length in the axial direction of the opening is set at the distance moved by the pressing member 40 or greater, there is no need for the large-diameter portion holding means 47 to move in accordance with the movement of the pressing member 40.

After the holding by the large-diameter portion holding means 47 has been released, as depicted in FIG. 5, the pressing member 40 is moved by the driving device 44 and successively crimps the respective spacer holes 12b.

Here, when the metal ball 20 passes through a spacer hole 12b and there is a sudden drop in the load stress of the pressing member 40 resulting in a force acting so as to cause deformation whereby the pressing member 40 bends, according to the second embodiment, the large-diameter portion 40a will collide with the inner circumferential surface of a through-hole 36a in the gap maintaining plates 36, which makes it possible to prevent the pressing member 40 from colliding with the inner circumferential portion of a spacer hole 12b and causing deformation of a spacer portion 12a.

Also, during the crimping process, since the large-diameter portion holding means 47 holds the large-diameter portion 40a at the position of a nodal point of the ultrasonic vibration until the large-diameter portion 40a of the pressing member 40 advances inside a spacer hole 12b, it is possible to suppress bending (deformation) of the pressing member 40 and make the pressing member 40 less susceptible to colliding with the inner circumferential surfaces of the spacer holes 12b, thereby preventing deformation of a spacer portions 12a.

### Third Embodiment

Next, a method of assembling a carriage assembly and an assembling apparatus according to a third embodiment will be described with reference to FIG. 7. Note that in the third embodiment, constructions that are the same as in the first embodiment have been assigned the same reference numerals and description thereof is omitted.

The assembling apparatus of a carriage assembly according to the third embodiment uses a construction that magnetizes at least an inner circumferential surface of a through-hole 36a in the gap maintaining plates 36 and a portion of the pressing member 40 that has advanced inside the spacer holes 12b with the same polarity in place of the through-hole diameter reducing means 46 in the first embodiment as a construction for suppressing the deformation of the pressing member 40.

In the construction depicted in FIG. 7, by magnetizing the inner circumferential surface of the through-hole 36a in the gap maintaining plates 36 and the pressing member 40 with the same polarity (for example, both parts are magnetized as north poles), the pressing member 40 will be repulsed by the inner circumferential surface of the gap maintaining plates 36, which makes it possible to suppress the deformation that bends the pressing member 40 when the metal ball 20 passes through a spacer hole 12b. Accordingly, the pressing member 40 becomes less susceptible to colliding with the inner circumferential surfaces of the spacer holes 12b, which makes it possible to prevent deformation of the spacer portions 12a.

1. A method of assembling a carriage assembly comprising:
an attaching step of positioning spacer holes provided in spacer portions of suspensions on through-holes that are formed with matching center axes in front end portions of a plurality of carriage arms that are used in a magnetic disk apparatus and have been disposed in parallel and attaching the suspensions to the respective carriage arms;
a holding step of inserting gap maintaining plates, in which through-holes that connect to the spacer holes have been formed, between adjacent carriage arms and holding the carriage arms by clamping in the direction in which the carriage arms are aligned; and
a crimping step of pressing a ball with a diameter that is equal to or larger than an inner diameter of the spacer holes using a bar-shaped pressing member that is subjected to ultrasonic vibration so as to pass the ball successively through the spacer holes of the respective suspensions and thereby crimp spacer hole inner circumferential portions of the spacer portions and attach the suspensions to the front end portions of the carriage arms,
wherein in the crimping step, after the ball has passed through one spacer hole out of the spacer holes, an inner diameter of the through-hole of the gap maintaining plates positioned to the rear of the spacer hole in the direction in which the ball passes is reduced to a smaller diameter than the inner diameter of the spacer holes.

2. A method of assembling a carriage assembly comprising:
an attaching step of positioning spacer holes provided in spacer portions of suspensions on through-holes that are formed with matching center axes in front end portions of a plurality of carriage arms that are used in a magnetic disk apparatus and have been disposed in parallel and attaching the suspensions to the respective carriage arms;
a holding step of inserting gap maintaining plates, in which through-holes that connect to the spacer holes have been formed, between adjacent carriage arms and holding the carriage arms by clamping in the direction in which the carriage arms are aligned; and
a crimping step of pressing a ball with a diameter that is equal to or larger than an inner diameter of the spacer holes using a bar-shaped pressing member that is subjected to ultrasonic vibration so as to pass the ball successively through the spacer holes of the respective suspensions and thereby crimp spacer hole inner circumferential portions of the spacer portions and attach the suspensions to the front end portions of the carriage arms,
wherein a large-diameter portion, which has a larger diameter than other parts of the pressing member but a smaller diameter than an inner diameter of the through-holes, is formed on the pressing member at a nodal point of the ultrasonic vibration.

3. A method of assembling a carriage assembly according to claim 2,
wherein the large-diameter portion is formed with a spherical surface.

4. A method of assembling a carriage assembly according to claim 2,
wherein during the crimping step, the large-diameter portion of the pressing member is held so as to not shake while the large-diameter portion is advancing inside a spacer hole.

5. A method of assembling a carriage assembly comprising:
an attaching step of positioning spacer holes provided in spacer portions of suspensions on through-holes that are formed with matching center axes in front end portions of a plurality of carriage arms that are used in a magnetic disk apparatus and have been disposed in parallel and attaching the suspensions to the respective carriage arms;
a holding step of inserting gap maintaining plates, in which through-holes that connect to the spacer holes have been formed, between adjacent carriage arms and holding the carriage arms by clamping in the direction in which the carriage arms are aligned; and
a crimping step of pressing a ball with a diameter that is equal to or larger than an inner diameter of the spacer holes using a bar-shaped pressing member that is subjected to ultrasonic vibration so as to pass the ball successively through the spacer holes of the respective suspensions and thereby crimp spacer hole inner circumferential portions of the spacer portions and attach the suspensions to the front end portions of the carriage arms,
wherein at least an inner circumferential surface of a through-hole in the gap maintaining plates and a part of the pressing member that advances inside the spacer holes are magnetized with the same polarity.

6. An assembling apparatus for a carriage assembly that uses the method of assembling a carriage assembly according to claim 1, comprising:
gap maintaining plates which are inserted between adjacent carriage arms in the attaching step in a state where the respective suspensions have been attached on the carriage arms and in which through-holes that connect to the spacer holes are formed;
carriage holding means for holding the plurality of carriage arms by clamping in the direction in which the carriage arms are aligned;
pressing means for pressing a bar-shaped pressing member in the direction of the center axes of the spacer holes so as to pass a ball, which has a diameter that is equal to or larger than the inner diameter of the spacer holes, successively through the spacer holes of the suspensions to crimp the spacer hole edge portions of the spacer portions and attach the suspensions to the front end portions of the respective carriage arms;
ultrasonic vibration applying means for applying ultrasonic vibration to the pressing member; and
through-hole diameter reducing means operable after the ball has passed one spacer hole out of the spacer holes, to reduce an inner diameter of the through-hole of the gap maintaining plates positioned to the rear of the spacer hole in the direction in which the ball passes to a smaller diameter than the inner diameter of the spacer holes.

7. An assembling apparatus for a carriage assembly that uses the method of assembling a carriage assembly according to claim 2, comprising:
gap maintaining plates which are inserted between adjacent carriage arms in the attaching step in a state where the respective suspensions have been attached on the carriage arms and in which through-holes that connect to the spacer holes are formed;
carriage holding means for holding the plurality of carriage arms by clamping in the direction in which the carriage arms are aligned;
pressing means for pressing a bar-shaped pressing member in the direction of the center axes of the spacer holes so as to pass a ball, which has a diameter that is equal to or larger than the inner diameter of the spacer holes, successively through the spacer holes of the suspensions to crimp the spacer hole edge portions of the spacer portions and attach the suspensions to the front end portions of the respective carriage arms; and
ultrasonic vibration applying means for applying ultrasonic vibration to the pressing member,
wherein a large-diameter portion, which has a larger diameter than other parts of the pressing member but a smaller diameter than an inner diameter of the through-holes, is formed on the pressing member at a nodal point of the ultrasonic vibration.

8. An assembling apparatus according to claim 7,
wherein the large-diameter portion is formed with a spherical surface.

9. An assembling apparatus according to claim 7,
further comprising large-diameter portion holding means for holding the large-diameter portion of the pressing member so as to not shake while the large-diameter portion advances inside a spacer hole.

10. An assembling apparatus for a carriage assembly that uses the method of assembling a carriage assembly according to claim 5, comprising:
gap maintaining plates which are inserted between adjacent carriage arms in the attaching step in a state where the respective suspensions have been attached on the carriage arms and in which through-holes that connect to the spacer holes are formed;
carriage holding means for holding the plurality of carriage arms by clamping in the direction in which the carriage arms are aligned;
pressing means for pressing a bar-shaped pressing member in the direction of the center axes of the spacer holes so as to pass a ball, which has a diameter that is equal to or larger than the inner diameter of the spacer holes, successively through the spacer holes of the suspensions to crimp the spacer hole edge portions of the spacer portions and attach the suspensions to the front end portions of the respective carriage arms; and
ultrasonic vibration applying means for applying ultrasonic vibration to the pressing member,
wherein the assembling apparatus magnetizes at least an inner circumferential surface of a through-hole in the gap maintaining plates and a part of the pressing member that advances inside the spacer holes with the same polarity.
